(19) United States
(12) Patent Application Publication
(10) Pub. No.: US 2006/0160524 A1
(43) Pub. Date: Jul. 20, 2006

(54) Method and apparatus to facilitate the support of communications that require authentication when authentication is absent

(75) Inventor: Michael Borella, Naperville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 11/038,877

(22) Filed: Jan. 20, 2005

(51) Int. Cl. H04M 1/66

(52) U.S. Cl. 455/411

(57) ABSTRACT

A network element (300) having a mobile Internet Protocol call processor (301) is provisioned with at least a first mode of operation and a second mode of operation. The first mode of operation causes the processor to require authentication information from an authentication server before supporting a mobile Internet Protocol call whereas the second mode of operation permits the processor to support a mobile Internet Protocol call notwithstanding an absence of authentication information. A mode of operation selector (305) selects the mode of operation to be utilized and can respond to, for example, present unavailability of authentication services and/or administrative preferences. Pursuant to one approach, information such as accounting information can be developed and maintained as corresponds to mobile Internet Protocol calls that are supported in the absence of authentication.

### TECHNICAL FIELD

This invention relates generally to network communications and more particularly to mobile Internet Protocol calls.

### BACKGROUND

It is known that some network communications ordinarily require authentication to receive network support. For example, when a mobile station seeks to initiate a mobile Internet Protocol call, a network element will contact an authentication server (preferably an Authentication, Authorization and Accounting (AAA) server) to ascertain whether that mobile station has authorization to use the network in the requested fashion. Upon confirming the authenticated status of the mobile station, the network element will respond with a corresponding authorization that in turn aids in facilitating the network's support of the requested mobile Internet Protocol call.

Sometimes, however, for any number of reasons, such authentication servers may be inoperable, unavailable, or otherwise unreachable. When this occurs, absent any other provision, such a network element will be unable to fully confirm the authorized status of the mobile station and will not allow the mobile station the requested network access. The network, in turn, will deny the requested mobile Internet Protocol call service to the mobile station.

To ameliorate, at least to some extent, such a situation, it is known to configure a Packet Data Serving Node (PDSN) to selectively operate in an alternative mode of operation. In particular, the PDSN can be configured to permit unauthorized simple Internet Protocol calls in the absence of explicit authorization when the PDSN is without ready access to an authentication server. This accommodation does, indeed, aid in resolving some aspects of the indicated problem. Unfortunately, however, the solution is incomplete.

For example, the present solution only addresses PDSN's. Other network elements can also serve as a network access server, however, such a home agent. Furthermore, by its very nature, this solution presents certain financial risks insofar as its implementation provides for a mode of operation whereby users gain access to the services of a communication network without authorization. Notwithstanding this risk, the present solution does little to provide comfort or control to a network administrator regarding its operation.

### BRIEF DESCRIPTION OF THE DRAWINGS

The above needs are at least partially met through provision of the method and apparatus to facilitate the support of communications that require authentication when authentication is absent described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a block diagram as configured in accordance with various embodiments of the invention; and

FIG. 4 comprises a signal flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a network element such as a home agent has at least two modes of operation. A first mode of operation requires authentication information from an authentication server when supporting a mobile Internet Protocol call. A second mode of operation does not require authentication information from an authentication server when supporting a mobile Internet Protocol call. The network element is then configured and arranged to switch to the second mode of operation as a function, at least in part, of the lack of available authentication services and/or administrative preference.

In a preferred approach, pursuant to the second mode of operation, the network element is able to provide a successful response to a mobile Internet Protocol registration reply notwithstanding a present utter lack of any available authentication service. If desired, the network entity, when operating in the second mode of operation, can process a Network Access Identifier (NAI), or some other form of identification, as proffered by the mobile station to determine whether a corresponding domain name is supported by, for example, the corresponding home agent. When the domain name is unsupported, the mobile Internet Protocol call request can be denied notwithstanding that the network element is otherwise above to permit an unauthorized mobile Internet Protocol call.

If desired, when operating in the second mode of operation, a network element such as a PDSN or a home agent can provide for corresponding record keeping with respect to at least some mobile Internet Protocol calls as are supported without authentication information from an authentication server. Such records can be locally maintained and/or transmitted to an accounting server.

So configured, network elements other than a PDSN are able to support unauthorized calls in the absence of an authentication capability. It is also possible to provide for at least a limited degree of authentication by considering the mobile station's indicated domain name and, in any event, the disclosed ability to maintain accounting records regarding permitted unauthorized calls that can be used for any number of beneficial administrative purposes that presently go unmet with present relevant solutions.

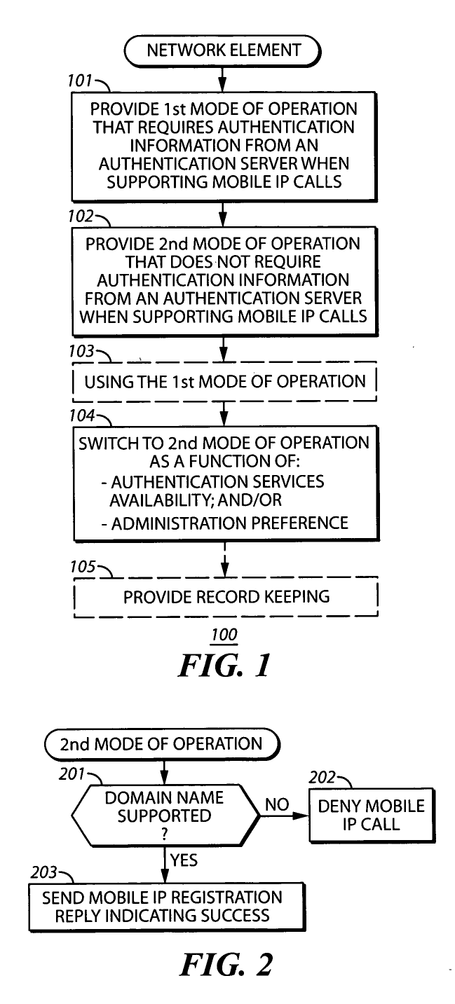

These and other benefits may become clearer upon making a thorough review and study of the following detailed description. Referring now to the drawings, and in particular to FIG. 1, a network element (such as a PDSN or a home agent) that ordinarily operates in cooperation with one or more authentication servers is provided 101 with a first mode of operation that requires authentication information from an authentication server when supporting a mobile Internet Protocol call.

This process 100 also provides 102 this network element with a second mode of operation that does not require authentication information from an authentication server when supporting a mobile Internet Protocol call. For example, pursuant to the second mode of operation the network element may be able to respond to a mobile Internet Protocol registration request with a mobile Internet protocol registration reply indicating success notwithstanding the absence of authentication from an authentication server.

Referring momentarily to FIG. 2, this second mode of operation can also, if desired, provide for determining 201 whether a Network Access Identifier (NAI) as corresponds to a given mobile Internet Protocol registration request identifies a domain name that is supported by the network element (for example, when the network element comprises a home agent). When the domain name is unsupported by the network element, the second mode of operation can deny 202 the mobile Internet Protocol registration request notwithstanding that the network element, as per the second mode of operation, is otherwise able to permit such a request in the absence of authentication information from an authentication server. Otherwise, when the domain name is supported by the network element, the network element can support the call request (for example, by sending 203 a mobile Internet Protocol registration reply indicating success).

Referring again to FIG. 1, this network element process 100 then provides for use 103 of the first mode of operation at times when sufficient authentication server resources are available. When authentication server resources are unavailable for whatever reason or cause, however, this process 100 permits the network element to switch 104 to the second mode of operation. This process 100 also permits such a switch as a function of, for example, administrative preference (as where an authorized network administrator provides a specific instruction to the network element to operate using the second mode of operation). Accordingly, it will be seen that these teachings are compatible for use with both automated and non-automated selection criteria to direct the initial and/or switched selection of the first and second modes of operation.

If desired, upon switching to (or otherwise selecting) the second mode of operation, this process 100 can also provide for corresponding record keeping 105 with respect to at least some mobile Internet Protocol calls as are supported without authentication information from an authentication server. For example, records can be maintained with respect to corresponding accounting information (such as, but not limited to, the identification of participating mobile stations, individual and aggregate call statistics regarding network resource usage, and so forth).

Such records can be locally maintained by the network element and/or can be transmitted to an accounting server of choice. For example, such accounting information can be transmitted to an accounting server using a Remote Authentication Dial-In User Service (RADIUS) message such as a message having an acct-authentic attribute (and/or a vendor specific attribute) set to a predetermined value that represents (by common agreement, standardization, or other convention) support of a non-authorized mobile Internet Protocol call.

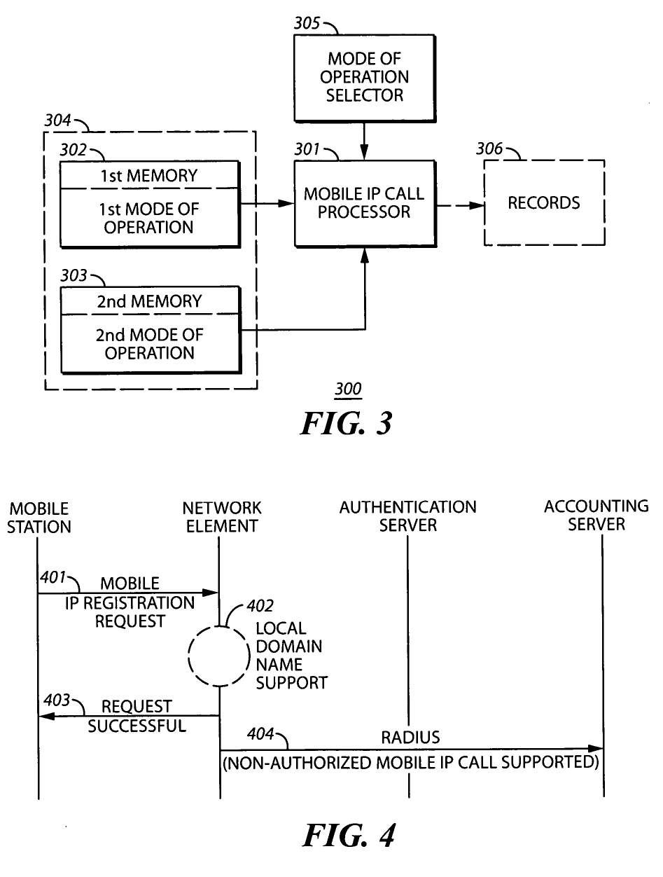

These teachings can be realized and enabled in a variety of ways. Referring now to FIG. 3, an illustrative example will be provided. A compliant network element 300 will typically comprise a mobile Internet Protocol (IP) call processor 301 in accordance with present practice. This processor 301 operably couples to a first and second memory 302 and 303 (which may comprise, of course, a single integrated storage entity 304 if desired) that contain, respectively, programming and instructions as pertain to the first and second modes of operation as described above.

The mobile Internet Protocol call processor 301 also preferably operably couples to a mode of operation selector 305 that serves to direct selection of or switching to a given one of the provisioned modes of operation. Pursuant to one approach, this mode of operation selector 305 is responsive to the detected availability of authentication services. Pursuant to another approach, this mode of operation selector 305 comprises a user interface and is responsive to user inputs as correspond to an evinced administrative preference.

So configured, and where the mobile Internet Protocol call processor 301 is configured and arranged to use either of the first and second modes of operation in accordance with the selections of the mode of operation selector 305, the network element 300 is readily configured and/or programmed to support the above-described processes. This, in turn, permits the mobile Internet Protocol call processor 301 to use the second mode of operation to respond to a mobile Internet Protocol registration request with a mobile Internet Protocol registration reply indicating success notwithstanding an absence of authorization by an authentication server. If desired, the mobile Internet Protocol call processor 301 can also determine whether a given mobile station's request provides a supported domain name in order to permit a local override of the blanket authorization that is otherwise effected by the second mode of operation.

The above-described apparatus can also be supplemented, if desired, with a records maintenance capability 306 to permit a corresponding PDSN, home agent, or other network access server to locally store or transmit information (such as accounting information) regarding unauthorized calls that have nevertheless been authorized as per the dictates of the second mode of operation.

An illustrative example appears at FIG. 4. Presuming unavailability of an authentication server (for whatever reason), when a mobile station transmits a mobile Internet Protocol registration request 401, the relevant network element can optionally determine whether that request identifies a supported local domain name 402. Then, presuming either that the domain name is supported or that the domain name test has not been applied, the network element can respond to the mobile station with an indication that the request is successful 403 while also providing corresponding accounting information 404 to an appropriate accounting server.

So configured, a network is more fully able to support continued operation and service notwithstanding an absence of authentication server capability. In addition to supporting unauthorized (or, viewed another way, unauthorizable) communications, these teachings also permit at least some degree of control by at least ascertaining whether a proffered domain name is supported and further provide for the optional development and maintenance of corresponding accounting information as pertains to the support of unauthorized mobile Internet Protocol calls.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method for use with a Home Agent that operates in cooperation with at least one authentication server comprising:
providing a first mode of operation that requires authentication information from an authentication server when supporting a mobile Internet Protocol call;
providing a second mode of operation that does not require authentication information from an authentication server when supporting a mobile Internet Protocol call;
switching from the first mode of operation to the second mode of operation as a function, at least in part, of at least one of authentication services availability and administrative preference.

2. The method of claim 1 wherein providing a second mode of operation that does not require authentication information from an authentication server when supporting a mobile Internet Protocol call comprises responding to a mobile Internet Protocol registration request with a mobile Internet Protocol registration reply indicating success.

3. The method of claim 1 wherein providing a second mode of operation that does not require authentication information from an authentication server when supporting a mobile Internet Protocol call comprises:
processing a Network Access Identifier as corresponds to a given mobile Internet Protocol registration request to determine whether a corresponding domain name is supported by the Home Agent;
responding to the mobile Internet Protocol registration request with a mobile Internet Protocol registration reply indicating success when the corresponding domain name is supported by the Home Agent.

4. The method of claim 1 and further comprising:
selecting which of the first and second mode of operation to use when supporting a mobile Internet Protocol call.

5. The method of claim 4 wherein selecting which of the first and second mode of operation to use when supporting a mobile Internet Protocol call further comprises automatically selecting which of the first and second mode of operation to use when supporting a mobile Internet Protocol call.

6. The method of claim 4 wherein selecting which of the first and second mode of operation to use when supporting a mobile Internet Protocol call further comprises selecting a mode of operation as a function, at least in part, of a corresponding user input.

7. The method of claim 1 wherein providing a second mode of operation that does not require authentication information from an authentication server when supporting a mobile Internet Protocol call further comprises providing a second mode of operation that also provides for record keeping with respect to at least some mobile Internet Protocol calls that are supported without authentication information from an authentication server.

8. The method of claim 7 wherein providing a second mode of operation that also provides for record keeping with respect to at least some mobile Internet Protocol calls that are supported without authentication information from an authentication server further comprises providing a second mode of operation that also provides for accounting information record keeping with respect to at least some mobile Internet Protocol calls that are supported without authentication information from an authentication server.

9. The method of claim 8 wherein providing a second mode of operation that also provides for record keeping with respect to at least some mobile Internet Protocol calls that are supported without authentication information from an authentication server further comprises transmitting accounting information to an accounting server.

10. The method of claim 9 wherein transmitting accounting information to an accounting server further comprises transmitting a Remote Authentication Dial-In User Service message.

11. The method of claim 10 wherein transmitting a Remote Authentication Dial-In User Service message further comprises transmitting a Remote Authentication Dial-In User Service message having an acct-authentic attribute set to a predetermined value that represents support of a non-authorized mobile Internet Protocol call.

12. The method of claim 10 wherein transmitting a Remote Authentication Dial-In User Service message further comprises transmitting a Remote Authentication Dial-In User Service message having a vendor-specific attribute set to a predetermined value that represents support of a non-authorized mobile Internet Protocol call.

13. A method for use with a network element that operates in cooperation with at least one authentication server comprising:
providing a mode of operation that does not require authentication information from an authentication server when supporting a mobile Internet Protocol call;
switching to the mode of operation that does not require authentication information from an authentication server as a function, at least in part, of at least one of authentication services availability and administrative preference;
providing record keeping with respect to at least some mobile Internet Protocol calls that are supported without authentication information from an authentication server.

14. The method of claim 13 wherein providing record keeping with respect to at least some mobile Internet Protocol calls that are supported without authentication information from an authentication server further comprises providing accounting information record keeping with respect to at least some mobile Internet Protocol calls that are supported without authentication information from an authentication server.

15. The method of claim 13 wherein providing record keeping with respect to at least some mobile Internet Protocol calls that are supported without authentication information from an authentication server further comprises transmitting accounting information to an accounting server.

16. The method of claim 15 wherein transmitting accounting information to an accounting server further comprises transmitting a Remote Authentication Dial-In User Service message.

17. The method of claim 16 wherein transmitting a Remote Authentication Dial-In User Service message further comprises transmitting a Remote Authentication Dial-In User Service message having an acct-authentic attribute set to a predetermined value that represents support of a non-authorized mobile Internet Protocol call.

18. The method of claim 16 wherein transmitting a Remote Authentication Dial-In User Service message further comprises transmitting a Remote Authentication Dial-In User Service message having a vendor-specific attribute set to a predetermined value that represents support of a non-authorized mobile Internet Protocol call.

19. The method of claim 13 and further comprising:
providing another mode of operation that requires authentication information from an authentication server when supporting a mobile Internet Protocol call.

20. The method of claim 19 wherein providing a mode of operation that does not require authentication information from an authentication server when supporting a mobile Internet Protocol call comprises responding to a mobile Internet Protocol registration request with a mobile Internet Protocol registration reply indicating success.

21. A Home Agent comprising:
a first memory having a first mode of operation that requires authentication information from an authentication server when supporting a mobile Internet Protocol call stored therein;
a second memory having a second mode of operation that does not require authentication information from an authentication server when supporting a mobile Internet Protocol call stored therein;
a mode of operation selector that is responsive to at least one of authentication services availability and administrative preference.

22. The Home Agent of claim 21 and further comprising:
a mobile Internet Protocol call processor that is operably coupled to the first and second memories and to the mode of operation selector and that is configured and arranged to selectively use the first and second modes of operation.

23. The Home Agent of claim 22 wherein the mobile Internet Protocol call processor comprises means for effecting the second mode of operation by responding to a mobile Internet Protocol registration request with a mobile Internet Protocol registration reply indicating success notwithstanding an absence of authorization by an authentication server.

24. The Home Agent of claim 22 wherein the mobile Internet Protocol call processor comprises means for effecting the second mode of operation by:
processing a Network Access Identifier as corresponds to a given mobile Internet Protocol registration request to determine whether a corresponding domain name is supported by the Home Agent;
responding to the mobile Internet Protocol registration request with a mobile Internet Protocol registration reply indicating success when the corresponding domain name is supported by the Home Agent.

25. The Home Agent of claim 21 wherein the mode of operation selector comprises a user interface.

26. The Home Agent of claim 22 wherein the mobile Internet Protocol call processor further comprises means for effecting the second mode of operation by effecting record keeping with respect to at least some mobile Internet Protocol calls that are supported without authentication information from an authentication server.

27. A network element comprising:
a first memory having a first mode of operation that requires authentication information from an authentication server when supporting a mobile Internet Protocol call stored therein;
a second memory having a second mode of operation that does not require authentication information from an authentication server when supporting a mobile Internet Protocol call stored therein;
a mode of operation selector that is responsive to at least one of authentication services availability and administrative preference;
a mobile Internet Protocol call processor that is operably coupled to the first and second memories and to the mode of operation selector and that is configured and arranged to selectively use the first and second modes of operation, wherein the mobile Internet Protocol call processor further comprises means for effecting the second mode of operation by effecting record keeping with respect to at least some mobile Internet Protocol calls that are supported without authentication information from an authentication server.
